(19) United States
(12) Patent Application Publication
(10) Pub. No.: US 2011/0043734 A1
(43) Pub. Date: Feb. 24, 2011

(54) LIQUID CRYSTAL DISPLAY PANEL

(76) Inventor: Chao-Jen Chang, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/611,081

(22) Filed: Nov. 2, 2009

(30) Foreign Application Priority Data
Aug. 18, 2009 (TW) 098127700

(51) Int. Cl. G02F 1/1333; G02F 1/1335; G02F 1/1339

(52) U.S. Cl. 349/106; 349/122; 349/155

(57) ABSTRACT

A liquid crystal display panel is disclosed. The liquid crystal display panel includes a first substrate, a second substrate, and a liquid crystal layer disposed between the first substrate and the second substrate. The first substrate has a flat plate, an active area, and a sealant supporting element disposed on a surface of the flat plate. The active area is encircled by the sealant supporting element. In addition, the sealant supporting element includes a top surface and a sealant trench concaving the top surface. A sealant is disposed in the sealant trench, and first substrate is connected to the second substrate by the sealant. Furthermore, the sealant is formed in the sealant trench for isolating the sealant from the liquid crystal layer.

### BACKGROUND OF THE INVENTION

1. Field of the Invention

The present invention relates to a liquid crystal display panel, and more particularly, to a liquid crystal display panel formed with a substrate having a monolithically-formed spacer on the surface.

2. Description of the Prior Art

With the improvement of the manufacturing techniques of liquid crystal displays, a liquid crystal display with a large size, high resolution, and high brightness is easily provided. In addition to improve the quality of the product and provide better specifications, quality control is a key point to enhance the product yield in manufacturing processes of liquid crystal displays. Take a thin film transistor liquid crystal display device as an example. The main processes include thin film transistor array engineering, color filter engineering, liquid crystal cell engineering, and liquid crystal module engineering.

Generally, liquid crystal cell engineering is to dispose a thin film transistor array substrate parallel and opposite to a color filter array substrate. A substrate is first spin coated with a sealant to define a region, liquid crystal is then filled in the region by a one drop fill (ODF) process, and spacers for maintaining the width between two substrates are dispersed in the interstice. Subsequently, a liquid crystal substrate is formed with some processes such as alignment, lamination, pressure application, and sealant hardening. However, a problem about non-uniform distribution may occur when dispersing granular spacers, and granular photoresist spacers (photospacers) are manufactured by a series of processes such as photoresist spin coating, exposure, development, and photoresist stripping. In addition, an ultraviolet hardening sealant is usually used to bond two substrates when assembling substrates, but it is founded in practical manufacturing processes that the liquid crystal of the liquid crystal display panel devices is often polluted by the partially hardened sealants to decrease the product yield and to lead to a bottleneck in the manufacturing processes.

### SUMMARY OF THE INVENTION

It is therefore one objective of the present invention to provide a liquid crystal display panel to solve the aforementioned problem about the liquid crystal polluted by the partially hardened sealants.

To achieve the above purpose, a liquid crystal display panel according to this invention is provided. The liquid crystal display panel includes a first substrate, a second substrate, and a liquid crystal layer disposed between the first substrate and the second substrate. The first substrate includes a flat plate, an active area, and a sealant supporting element. The sealant supporting element is disposed on the surface of the flat plate, encircles the active area, and extends outside the surface of the flat plate, wherein the sealant supporting element has a top surface and a sealant trench concaving the top surface. A sealant is disposed in the sealant trench, and the first substrate is connected to the second substrate by the sealant.

In addition, it is another objective of the present invention to provide a liquid crystal display panel to simplify the manufacturing processes of liquid crystal displays.

To achieve the above purpose, another liquid crystal display panel according to this invention is provided. The liquid crystal display panel includes a thin film transistor array substrate, a color filter substrate, a reflective electrode, and a liquid crystal layer disposed between the thin film transistor array substrate and the color filter substrate. The reflective electrode is disposed on the thin film transistor array substrate and includes a reflective body and at least a spacer disposed on a surface of the reflective body adjacent to the color filter substrate, wherein the reflective body and the spacer are formed monolithically.

The liquid crystal display panel of the present invention is formed with a monolithically-formed substrate having a sealant supporting element or spacers. In manufacturing processes of liquid crystal displays, processes to fabricate additional spacers for maintaining the width between two substrates are no longer required. Therefore, it simplifies the manufacturing processes of liquid crystal displays, reduces the manufacturing time, and improves the product efficiency.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-4 are schematic diagrams illustrating a liquid crystal display panel and a method of forming the same according to a first preferred embodiment of the present invention.

FIG. 5 schematically illustrates a liquid crystal display panel according to a second preferred embodiment of the present invention.

FIG. 6 schematically illustrates a liquid crystal display panel according to a third preferred embodiment of the present invention.

### DETAILED DESCRIPTION

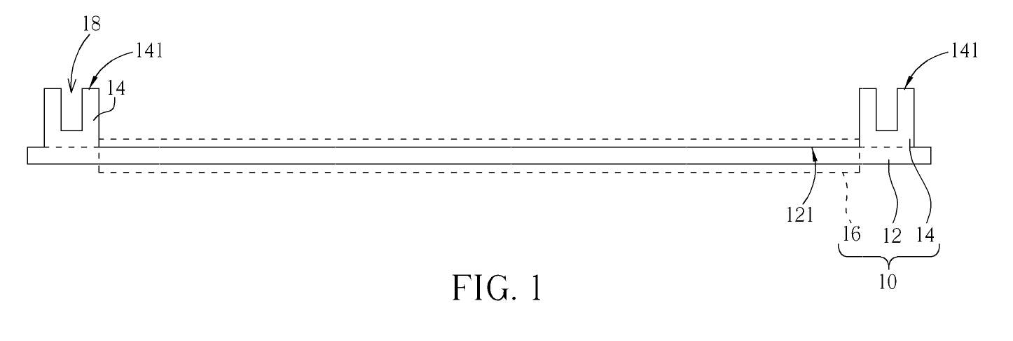

FIGS. 1-4 are schematic diagrams illustrating a liquid crystal display panel and a method of forming the same according to a first preferred embodiment of the present invention. As shown in FIG. 1, a first substrate 10 is provided. The first substrate includes a flat plate 12 and a sealant supporting element 14, wherein an active area 16 is disposed on a surface 121 of the flat plate 12, and a sealant supporting element 14 is also disposed on the surface 121 and extends outside the surface 121 of the flat plate 12. In addition, the active area 16 is encircled by the sealant supporting element, and a height of the sealant supporting element 14 is larger than a thickness of the flat plate 12. Furthermore, the sealant supporting element 14 includes a top surface 141 and a sealant trench 18 concaving the top surface 141, a depth of the sealant trench 18 is not larger than a height of the sealant supporting element 14, and an aperture width of the sealant trench 18 is not larger than a width of the sealant supporting element 14. It should be noted that the first substrate 10 is formed monolithically, i.e. the sealant supporting element 14 and the flat plate 12 are formed with the same material. For example, a mold may be filled with a transparent material such as resin, plastic, or glass, and a monolithically-formed technique, such as a vacuum molding process or an injection molding process, may be used to form simultaneously the sealant supporting element 14 and the flat plate 12 of the first substrate 10. Furthermore, the first substrate 10 may be formed in another method. For example, a substrate with a uniform thickness is formed with the aforementioned material, and an etching process is used to form simultaneously the sealant supporting element 14 and the flat plate 12 of the first substrate 10.

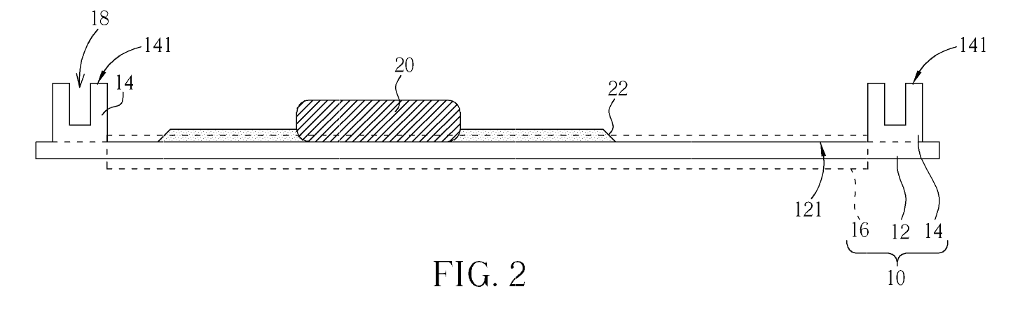

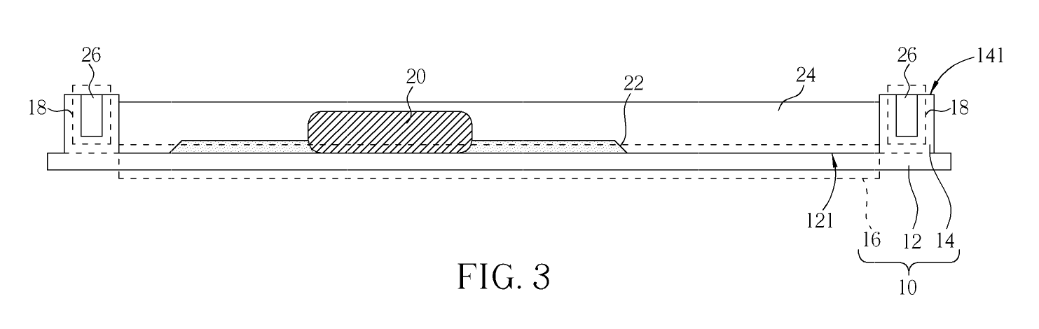

As shown in FIG. 2, all kinds of components of the liquid crystal display panel may be formed in the active area 16, such as a color photoresist 20 and a black matrix 22 disposed around the color photoresist 20. In addition, an alignment film and a transparent conductive layer may be formed in the active area 16 to adjust the direction of the liquid crystal, wherein the transparent conductive layer may be an indium tin oxide (ITO) layer or an indium zinc oxide (IZO) layer. Then, as shown in FIG. 3, a one drop fill process is performed to form a liquid crystal layer 24 in the active area 16, and a sealant 26, such as an ultraviolet hardening sealant, a laser light hardening sealant, an infrared hardening sealant, a visible light hardening sealant, or another light hardening sealant, is spin coated in the sealant trench 18

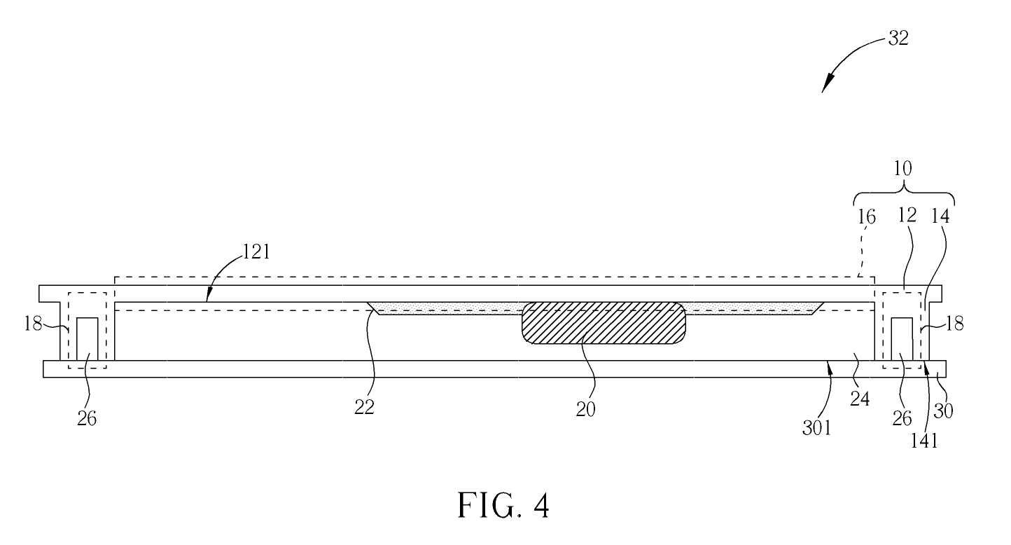

As shown in FIG. 4, second substrate 30 is provided and includes a thin film transistor array circuit (not shown in the figure) disposed on a surface 301 of the second substrate 30. The surface 301 of second substrate 30 with the thin film transistor array circuit is then disposed adjacent to the first substrate 10. By processes such as an alignment process, a lamination process, and a sealant hardening process, the first substrate 10 is connected to the second substrate 30 by the sealant 26 in the sealant trench 18 to form a liquid crystal display panel 32. In addition, the sealant 26 in this embodiment is restricted in the sealant trench 18 of the sealant supporting element 14 (as shown in FIGS. 2-3). Therefore, in the processes of connecting the first substrate 10 and the second substrate 30, the sealant 26 is out of contact with the liquid crystal layer 24, and the problem about liquid crystal layer 24 being polluted by the partially hardened sealant 26 may be avoided. Furthermore, additional spacers are no longer required since the sealant supporting element 14 with a definite height and elasticity can be used to maintain the width between the first substrate 10 and the second substrate 30. As a result, in the manufacturing process of the liquid crystal display panel of this invention with the first substrate having the sealant supporting element, the conventional step such as dispersing spacers in the sealant and in the liquid crystal layer or forming photoresist spacers by a lithographic process can be removed, and the design of the sealant trench can prevent the sealant from contacting the liquid crystal layer and avoid the pollution in the liquid crystal layer. The first substrate of this embodiment can be used in all kinds of liquid crystal display panels. For example, the substrate of this embodiment with a color filter can be connected to a thin film transistor array substrate with a thin film transistor array circuit to form a liquid crystal display panel. In another way, the aforementioned second substrate may be replaced by a color filter array substrate, and the first substrate of this invention with the sealant supporting element may serve as an upper substrate corresponding to the color filter array substrate. Furthermore, the first substrate of this invention with the sealant supporting element may be used in a reflective liquid crystal display panel or in a touch panel.

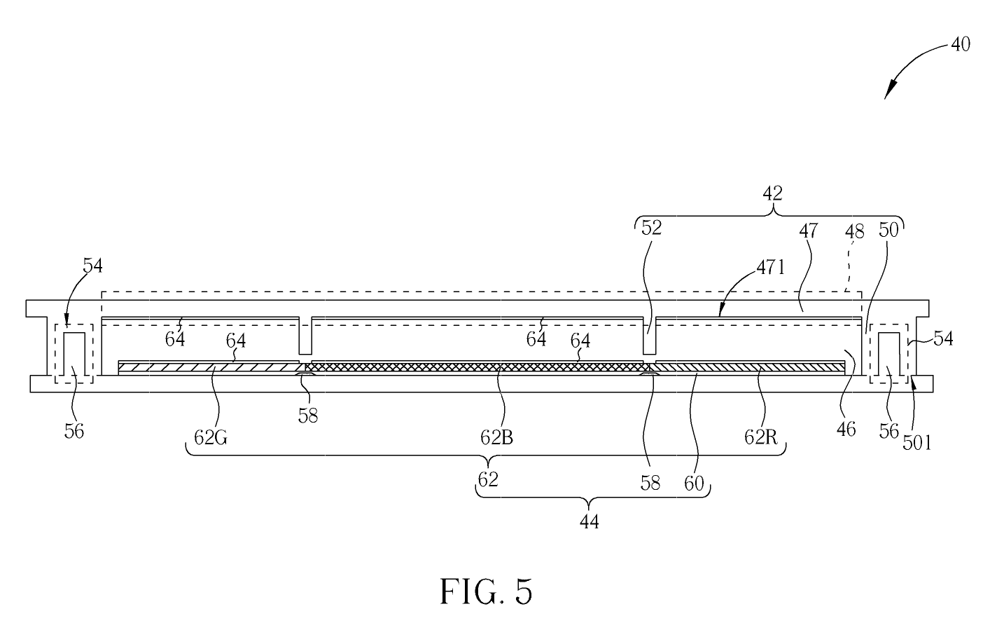

FIG. 5 schematically illustrates a liquid crystal display panel 40 according to a second preferred embodiment of the present invention. As shown in FIG. 5, the liquid crystal display panel 40 includes a first substrate 42, a second substrate 44 disposed in opposition to first substrate 42, and a liquid crystal layer 46 disposed between the first substrate 42 and the second substrate 44. The first substrate 42 includes a flat plate 47, an active area 48 disposed on a surface 471 of the flat plate 47, a sealant supporting element 50 disposed on the surface 471 and encircling the active area 48, and at least a spacer 52 disposed in the active area 48, wherein the sealant supporting element 50 and the spacer 52 extend outside the surface 471 of the flat plate 47, a height of the sealant supporting element 50 and a height of the spacer 52 are larger than a thickness of the flat plate 47. The same as in the first preferred embodiment, the sealant supporting element 50 includes a top surface 501 and a sealant trench 54 concaving top surface 501 used for holding the sealant 56 to connect the first substrate 42 to the second substrate 44. In addition, a depth of the sealant trench 54 is not larger than a height of the sealant supporting element 50, and an aperture width of the sealant trench 56 is not larger than a width of the sealant supporting element 50. It should be noted that the first substrate 42 is formed monolithically, i.e. the flat plate 47, the sealant supporting element 50, and the spacer 52 are formed with the same material, and the manufacturing processes are the same as that mentioned in the first preferred embodiment. Furthermore, the second substrate 44 is a color filter array substrate, and the second substrate 44 includes a thin film transistor array circuit 58, a planar layer 60 covering the thin film transistor array circuit 58, and a color filter layer 62 disposed on the thin film transistor array circuit 58, wherein the color filter layer 62 includes a plurality of color photoresists, such as a red photoresist 62R, a blue photoresist 62B, and a green photoresist 62G, and metal lines of the thin film transistor array circuit 58, such as data lines, are located respectively corresponding to each spacer 52 of the first substrate 42. The metal lines can also have a function of light shading. The liquid crystal display panel 40 includes a transparent conductive layer 64 disposed respectively on the surface 471 of the first substrate 42 and on the color filter layer 62 and used to control the spin of the liquid crystal. Compared to the first preferred embodiment, the first substrate 42 of the liquid crystal display panel 40 of the second preferred embodiment has spacers 52 with a definite height in the active area 48 to maintain the width between the first substrate 42 and the second substrate 44, i.e. the thickness of the liquid crystal layer 46. In addition, the sealant supporting element 50 not only can maintain the width between the substrates, but also can restrict the sealant 56 in the sealant trench 54 to prevent the sealant 56 from polluting the liquid crystal layer 46.

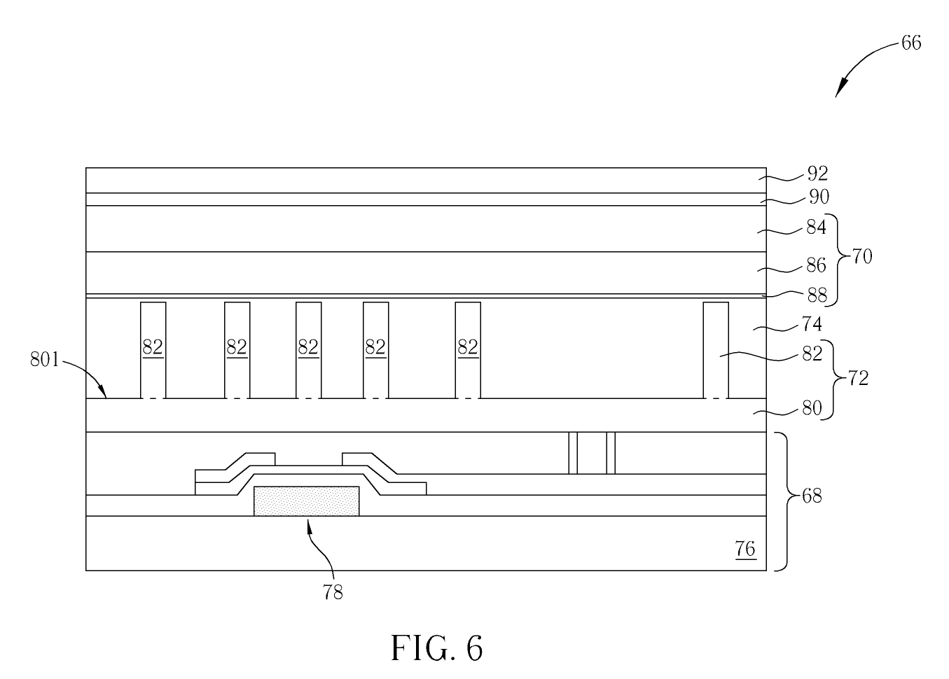

FIG. 6 schematically illustrates a liquid crystal display panel 66 according to a third preferred embodiment of the present invention. The liquid crystal display panel 66 includes a thin film transistor array substrate 68, a color filter substrate 70, a reflective electrode 72, and a liquid crystal layer 74 disposed between the thin film transistor array substrate 68 and the color filter substrate 70. As shown in FIG. 6. the liquid crystal display panel 66 is a reflective liquid crystal display panel or a transflective liquid crystal display panel, and the thin film transistor array substrate 68 includes a substrate 76 and a thin film transistor array circuit 78 disposed on the substrate 76. The reflective electrode 72 is disposed on the thin film transistor array substrate 68, and the reflective electrode 72 includes a reflective body 80 and at least a spacer 82 disposed on a surface 801 of the reflective body 80 adjacent to the color filter substrate 70, wherein the reflective body 80 and the spacers 82 are formed monolithically with a reflective material, such as aluminum, silver, nickel, chromium, or an alloy thereof. In the manufacturing process of the reflective electrode 72, a metal layer with a definite thickness may be formed first, and the metal layer is then patterned by an etching technique or another patterning technique to form simultaneously a reflective body 80 and spacers 82 on the surface 801, wherein a height of the spacers 82 is larger than a thickness of the reflective body 80. The spacers 82 of the reflective electrode 72 disposed in the liquid crystal display panel 66 can maintain the thickness between two substrates, and an incident light can be reflected by the reflective body 80 of the reflective electrode 72. The color filter substrate 70 of the liquid crystal display panel 66 includes a substrate 84, a color filter layer 86, and a transparent conductive layer 88 disposed on a side of the substrate 84 adjacent to thin film transistor array substrate 68, wherein the transparent conductive layer 88 corresponding to the reflective electrode 72 on the thin film transistor array substrate 68 is used to control the spin of the liquid crystal. In addition, a plurality of optical thin films, such as a phase difference plate (λ/4 film) and a polarizing plate, are formed adjacent to the color filter substrate 70 and opposite the color filter substrate 70 from the thin film transistor array substrate 68, for adjusting light beams transmitting from the liquid crystal display panel 66. In the manufacturing process of the reflective electrode 72 according to the third preferred embodiment of the present invention, the reflective body 80 for reflecting light beams and the spacer 82 for maintaining the width between two substrates are formed simultaneously. Therefore, an additional process for manufacturing the spacers is removed, and it simplifies the manufacturing process of the liquid crystal display panel.

As a result, the present invention simplifies the conventional manufacturing process of the liquid crystal display panel. When a substrate or a reflective electrode required in the liquid crystal display panel is fabricated, the spacer for maintaining the width between two substrates is simultaneously formed on the substrate or on the reflective electrode to simplify the manufacturing process. Furthermore, the sealant supporting element for maintaining the width between two substrates has the sealant trench for holding the sealant to prevent the partially hardened sealant from polluting the liquid crystal layer, and the conventional process for fabricating spacers can be removed to decrease the manufacturing time and to reduce the product cost.

Those skilled in the art will readily observe that numerous modifications and alterations of the device and method may be made while retaining the teachings of the invention.

What is claimed is:

1. A liquid crystal display panel, comprising:
a first substrate, comprising:
a flat plate;
an active area disposed on a surface of the flat plate; and
a sealant supporting element, disposed on the surface of the flat plate, encircling the active area, and extending outside the surface of the flat plate, wherein the sealant supporting element has a top surface and a sealant trench concaving the top surface;
a second substrate, disposed in opposition to the first substrate;
a liquid crystal layer, disposed among the first substrate, the second substrate, and the sealant supporting element; and
a sealant, disposed in the sealant trench, wherein the first substrate is connected to the second substrate by the sealant.

2. The liquid crystal display panel of claim 1, wherein the sealant supporting element and the flat plate are formed monolithically.

3. The liquid crystal display panel of claim 1, wherein a material of the flat plate is the same as a material of the sealant supporting element.

4. The liquid crystal display panel of claim 1, wherein a height of the sealant supporting element is larger than a thickness of the flat plate.

5. The liquid crystal display panel of claim 1, wherein the first substrate comprises at least a spacer disposed in the active area.

6. The liquid crystal display panel of claim 5, wherein a material of the spacer is the same as a material of the sealant supporting element.

7. The liquid crystal display panel of claim 5, wherein a height of the spacer is larger than a thickness of the flat plate.

8. The liquid crystal display panel of claim 1, wherein the first substrate is a glass substrate or a plastic substrate.

9. The liquid crystal display panel of claim 1, wherein the first substrate is a color filter substrate and the first substrate comprises a plurality of color photoresists disposed in the active area.

10. The liquid crystal display panel of claim 9, wherein the color photoresists comprise at least a red photoresist, at least a blue photoresist, and at least a green photoresist.

11. The liquid crystal display panel of claim 1, wherein the second substrate is a thin film transistor array substrate.

12. The liquid crystal display panel of claim 1, wherein the second substrate is a color filter array substrate.

13. The liquid crystal display panel of claim 1, wherein the liquid crystal display panel is a reflective liquid crystal display panel.

14. The liquid crystal display panel of claim 1, wherein the liquid crystal display panel is a touch panel.

15. A liquid crystal display panel, comprising:
a thin film transistor array substrate;
a color filter substrate, disposed in opposition to the thin film transistor array substrate, wherein the color filter substrate comprises a color filter layer disposed on a surface of the color filter substrate adjacent to the thin film transistor array substrate;
a reflective electrode, disposed on the thin film transistor array substrate, wherein the reflective electrode comprises:
a reflective body; and
at least a spacer, disposed on a surface of the reflective body adjacent to the color filter substrate, wherein the reflective body and the spacer are formed monolithically; and
a liquid crystal layer, disposed between the thin film transistor array substrate and the color filter substrate.

16. The liquid crystal display panel of claim 15, wherein a material of the reflective electrode is aluminum, silver, nickel, chromium, or an alloy thereof.

17. The liquid crystal display panel of claim 15, wherein a height of the spacer is larger than a thickness of the reflective body.

18. The liquid crystal display panel of claim 15, wherein a plurality of optical thin films are formed adjacent to the color filter substrate and opposite the color filter substrate from the thin film transistor array substrate.

19. The liquid crystal display panel of claim 18, wherein the optical thin films comprise a phase difference plate (λ/4 film) and a polarizing plate.
